(19) United States
(12) Patent Application Publication
(10) Pub. No.: US 2026/0284952 A1
(43) Pub. Date: Sep. 24, 2026

(54) SCREW ELEMENTS WITH IMPROVED MIXING EFFECT AND IMPROVED HEAT TRANSFER, AND THE USE OF SAME

(71) Applicant: Covestro Deutschland AG, Leverkusen (DE)

(72) Inventors: Thomas Koenig, Leverkusen (DE); Michael Bierdel, Leverkusen (DE)

(21) Appl. No.: 19/479,781

(22) PCT Filed: Apr. 22, 2024
(86) PCT No.: PCT/EP2024/060957

§ 371 Date: Oct. 29, 2025

(30) Foreign Application Priority Data
May 4, 2023 (EP) 23171688.7

(51) Int. Cl. B29C 48/40; B29C 48/25; B29C 48/27; B29C 48/405; B29C 48/55; B29C 48/57; B29C 48/655

(52) U.S. Cl. CPC B29C 48/402; B29C 48/2517; B29C 48/405; B29C 48/55; B29C 48/57; B29C 48/655; B29C 48/2715

(57) ABSTRACT

The present disclosure relates to a pair of three-lead screw elements for a multi-shaft screw machine having screw shafts rotating in the same direction and at the same speed. The two screw elements of the pair of screw elements according to the disclosure, opposing each other directly adjacently on two directly adjacent screw shafts, are mutually cleaned in a practical manner. The present disclosure also relates to the use of the pair of screw elements in a multi-shaft screw machine, to a multi-shaft screw machine equipped with a pair of screw elements, and to a method for extruding plastic or viscoelastic compounds using the pair of screw elements.

### CROSS-REFERENCE TO RELATED APPLICATIONS

This application is a U.S. national stage application, filed under 35 U.S.C. § 371, of International Application No. PCT/EP2024/060957, which was filed on Apr. 22, 2024, and which claims priority to European Application No. 23171688.7, which was filed on May 4, 2023. The contents of each are hereby incorporated by reference into this specification.

### FIELD

The invention relates to a pair of three-flight screw elements for a multishaft screw machine with screw shafts rotating in the same direction and at the same speed. The two screw elements of the pair of screw elements according to the invention, which are located directly adjacent on two directly adjacent screw shafts opposite each other, practically clean each other. The invention also relates to the use of the pair of screw elements according to the invention in a multishaft screw machine and to a multishaft screw machine which is equipped with a pair of screw elements according to the invention, as well as to a method for the extrusion of plastic or viscoelastic masses using the pair of screw elements according to the invention.

### BACKGROUND

In the context of the present invention, a multishaft screw machine is understood to mean a screw machine having more than one screw shaft, for example a screw machine having two, three or four screw shafts or else a screw machine having eight to sixteen, especially twelve, screw shafts in an annular arrangement. In the case of more than two screw shafts, the axes of rotation of the screw shafts may be arranged next to one another, or else, for example-as in the case of what is called a ring extruder—in annular form. In multishaft extruders, the axes of rotation of the screw shafts are generally arranged parallel to each other. This parallel arrangement of the axes of rotation is also favored according to the invention. The screw elements according to the invention are preferably arranged oppositely on the screw shafts in a number that corresponds to the number of screw shafts of the respective extruder. Such a screw machine having more than one screw shaft is also referred to hereinafter as a multiple-shaft screw machine, multishaft screw machine or multishaft extruder. A twin-shaft screw machine is also referred to hereinafter as a twin-screw extruder. In the context of the present invention, the term “screw machine” is used synonymously with the term “extruder”.

### SUMMARY

Modern extruders have a modular system in which various screw elements can be mounted on a core shaft to form a screw shaft; such a screw shaft is therefore segmented. This allows a person skilled in the art to adapt the extruder to the respective process task. However, a screw shaft can also be made in one piece, i.e. can have only one screw element that extends substantially over the entire length of the screw shaft, or can be only partially segmented. The present invention relates both to screw elements that can be mounted on a core shaft and to the screw shafts made from a single piece described above.

### BRIEF DESCRIPTION OF FIGURES

FIG. 1 shows a cross section of a pair of three-flight screw elements for a co-rotating twin-screw extruder, thus showing the screw cross-sectional profiles of these screw elements.

FIG. 2A shows a plan view of a pair of three-flight screw elements for a co-rotating twin-screw extruder according to the invention, which practically scrape each other.

FIG. 2B shows the screw profiles of the screw elements from FIG. 2A.

FIG. 2C shows a cross section of the precisely scraping pair of three-flight screw elements from FIGS. 2A and 2B, i.e., it shows the screw cross-sectional profiles of these screw elements.

FIG. 3 shows the screw profiles of another pair of screw elements according to the invention.

FIGS. 4A to 4H show various screw profiles according to the invention with different sequences of crests and grooves.

FIG. 5 shows the screw profiles of another pair of screw elements according to the invention.

### DETAILED DESCRIPTION

Co-rotating twin-screw machines of which the screw shafts clean each other precisely have been known for a long time, e.g. from DE 862 668 C. In polymer production and processing, screw machines with screw shafts of which the screw elements are based on the principle of precisely cleaning screw cross-sectional profiles have been used in a variety of ways. This is mainly due to the fact that polymer melts adhere to surfaces and degrade over time at normal processing temperatures, which is prevented by the self-cleaning effect of screw elements in multishaft machines that precisely clean each other in pairs. Rules for generating cross-sectional screw profiles for screw elements which clean each other exactly are shown, for example, in [1] ([1]=Klemens Kohlgrüber: “Der gleichläufige Doppelschneckenextruder” [Codirectional Twin-Screw Extruders], 2nd Edition, Hanser Verlag München 2016, pages 107 to 120). According to the description there, in the case of screw elements which clean each other exactly, a predetermined cross-sectional screw profile on the first shaft of a twin-screw extruder determines the cross-sectional screw profile on the second shaft of the twin-screw extruder ([1], page 108). A screw cross-sectional profile, also referred to as a screw profile for short in the context of the present invention, is understood to mean the outer contour of a screw element in a plane section at right angles to the axis of rotation of the screw element, in accordance with the axis of rotation of the associated screw shaft. The screw profile for the screw element on the first shaft is referred to as the generating screw profile. The screw profile for the screw element on the second shaft follows from the screw profile of the first shaft of the twin-screw extruder and is therefore referred to as the generated screw profile. In a multishaft extruder, the screw element with the generating screw profile and the screw element with the generated screw profile are always used alternately on neighboring shafts.

A person skilled in the art of screw elements will of course understand that a single screw element or screw profile on its own cannot be precisely scraping or practically scraping, but that a pair of such elements is always required.

Two things need to be distinguished here: The precisely scraping screw profile, a mathematical construct in which two screw elements, which lie opposite each other on two immediately neighboring screw shafts, clean each other without any clearance, and screw profiles for screw elements designed in material reality for the intended use, i.e., technically executed screw elements.

A person skilled in the art is aware, and it is stated for example in [1], on pages 39 to 41 and on pages 113 to 121, that technically designed screw elements must have clearances-both screw element-to-screw element clearances s and screw element-to-housing bore inner wall clearances δ (referred to within the scope of the present invention as screw element-to-housing bore inner wall gap S)—in order to ensure the functionality of the extruder. This is necessary to avoid metallic “seizure”, manufacturing tolerances, roughness, angular deviations, uneven thermal expansion and excessive extrudate stress due to insufficient spacing between two screw elements that are directly adjacent to each other on two directly neighboring screw shafts. The pages mentioned also explain methods for determining the exact geometry of the element to be produced from the clearances and the precisely scraping contour. These methods are called clearance strategies.

For the purposes of the present invention, a clearance—also referred to within the scope of the present invention as s—is understood to be the distance between the closest points of the screw profiles of two screw elements that practically clean each other. The rules for generating screw profiles with clearances stated in [1] are applicable to the screw elements according to the invention.

For the purposes of the present invention, a gap—also referred to within the scope of the present invention as S—is understood to be the distance between a crest of a screw profile and the closest point of the housing bore inner wall of an extruder. The housing bore inner wall of an extruder is also referred to below as the housing inner wall for short.

If the term “precisely cleaning” is used in the context of the present invention, this means-unless otherwise stated—the mathematical construct of a precisely cleaning screw profile or the corresponding screw element having this screw profile. If the term “practically cleaning” is used in the context of the present invention, this means-unless otherwise explained—the technically executed screw element or its screw profile, wherein this practically cleaning screw profile has been derived from a precisely cleaning screw profile, preferably by applying one of the clearance strategies: center distance increase, longitudinal section equidistant, circular equidistant or spatial equidistant, particularly preferably by applying one of the clearance strategies: longitudinal section equidistant, circular equidistant or spatial equidistant, as explained in more detail below.

The strategies of longitudinal section equidistant, circular equidistant and spatial equidistant are also referred to below as the longitudinal section equidistant calculation rule, circular equidistant calculation rule and spatial equidistant calculation rule.

Multishaft extruders, especially twin-screw extruders, are known to transfer mechanical energy into an extrudate by dissipation. This has desirable and undesirable consequences because, on the one hand, the energy input is required to fulfil process engineering tasks such as mixing and degassing and, on the other hand, the mechanical energy input is consumed and also leads to temperature increases in the extrudate, which can lead to undesirable chemical reactions that damage the extrudate.

Mixing is also known to be a basic operation in multishaft extruders, especially twin-screw extruders. Inhomogeneities in the extrudate due to imperfect mixing are known to lead to problems in the further processing of the extrudate and in the final properties.

In a twin-screw extruder, the extrudate is sheared particularly strongly between a screw crest and the inner wall of the extruder housing bore. This means that a particularly large amount of energy is dissipated into the extrudate, which leads to strong localized overheating in the extrudate. This is shown, for example, in [1] on pages 416 to 423, images 4.80 to 4.84. This local overheating can lead to damage in the extrudate, such as changes in odor, color, chemical composition or molecular weight or to the formation of inhomogeneities in the extrudate such as gel bodies or specks. In particular, a large crest angle and especially a large sum of the crest angles of a pair of screw elements that lie opposite each other on directly neighbouring screw shafts and scrape each other is detrimental.

Screw elements that aim to improve the mixing effect have been the subject of technical development for a long time. Numerous known geometries neglect the fact that screw elements should advantageously clean each other, such as all variants of toothed mixing elements, for example DE 4 134 026 A1, DE 19 706 134 A1 or WO 2004 009 326 A1. This class of mixing elements is fundamentally characterized in that a screw thread is equipped with openings or grooves that interrupt the material transport and ensure improved mixing. However, the surfaces in the openings or grooves are not cleaned kinematically, so that material can adhere at these points, degrade and become a source of contamination for the extrudate—in this case the plastic or viscoelastic mass to be extruded.

However, mixing elements with complete self-cleaning have also been known for a long time. For example, DE 940 109 C already disclosed three-flight kneading disks that provided an improved mixing effect compared to continuously running screw flights.

DE 3 412 258 A1 teaches how gaps between the screw crests and the housing inner wall can be designed for three- and four-flight screw elements for twin-screw extruders. The extrudate is sheared in a targeted manner by a different gap at the screw crests. For this purpose, a symmetrical arrangement of three- or four-flight screw profiles of a twin screw, which a priori have the same gap S (there called s) to the housing inner wall at all screw crests, is displaced parallel from the centers of rotation with an eccentricity e that is smaller than s.

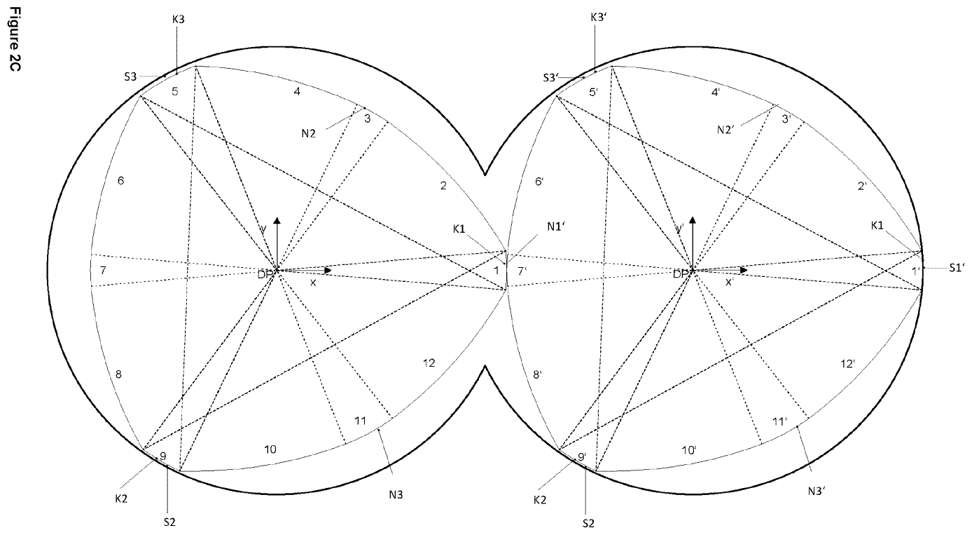

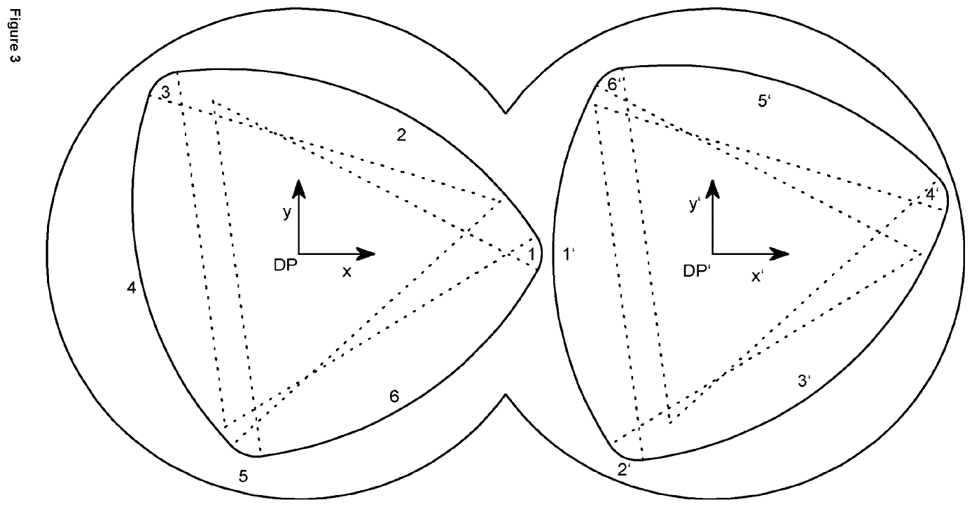

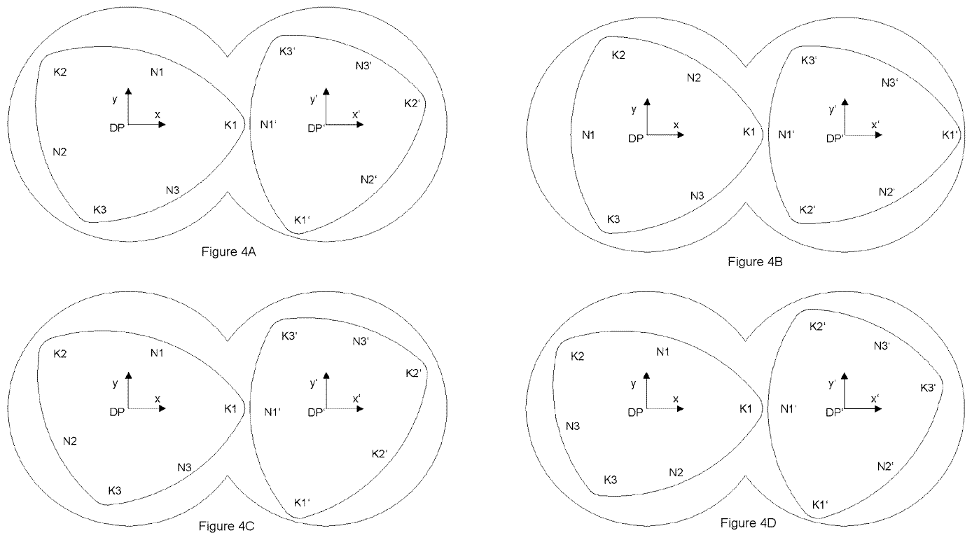

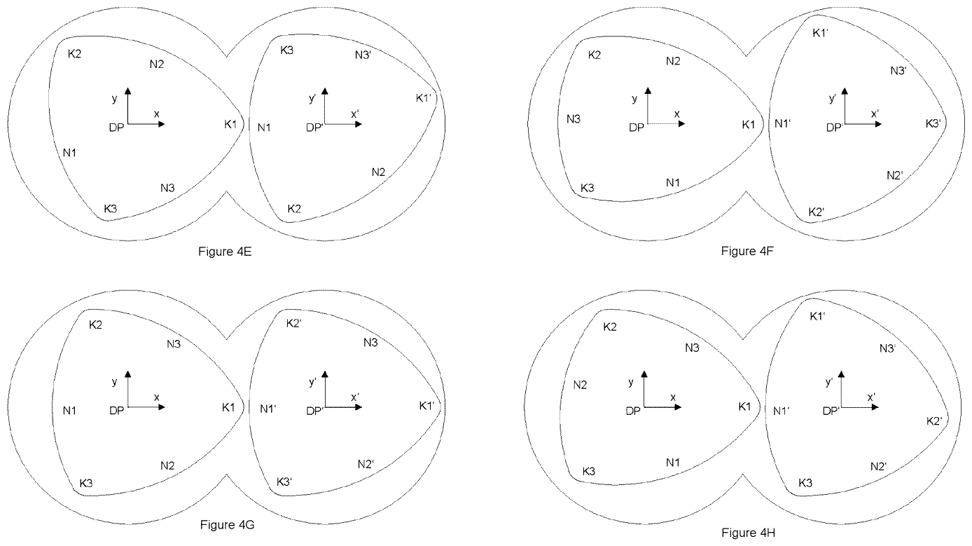

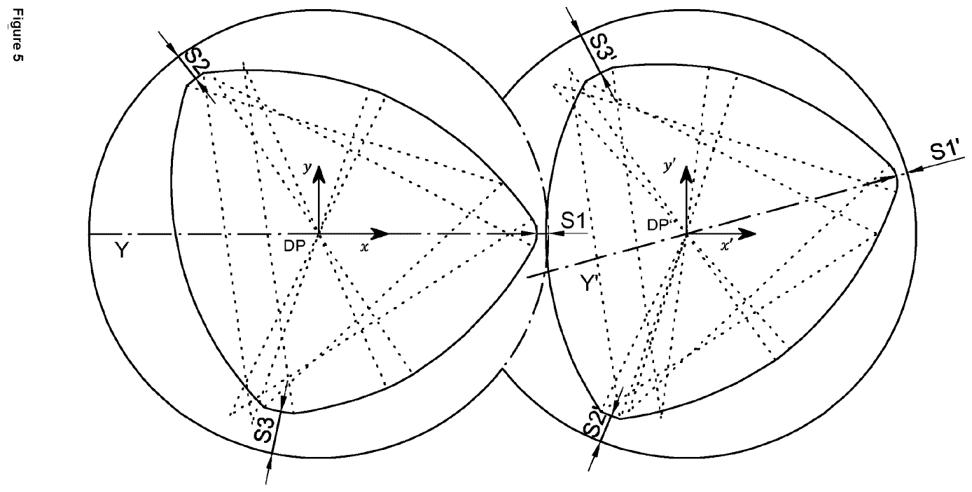

EP 2 131 A1 discloses a method for producing self-cleaning screw elements in pairs, wherein the individual screw crests of these screw elements have a different gap to the housing inner wall. The gap width of an individual screw crest can be increased here up to half the flight depth H. The aim here is also to create a material exchange between the individual screw flights and to shear the material in a targeted manner as it passes over the screw crest. The resulting two-flight screw elements have no axes of symmetry and different crest angles at the two screw crests. Three- and four-flight screw elements are also claimed. With the three-flight screw elements, the gap is enlarged at a screw clearance (FIG. 4). The flight depth H is understood here to be half the distance which is the difference between the outer diameter da of the screw element and the core diameter d₁ of the screw element, i.e., H=(DA−DA)/2. This application does not teach anything about avoiding damage to the extrudate and improved heat transfer.

DE 42 39 220 A1 describes three-flight screw elements that have different gaps and different crest angles at the three crests, wherein the screw crest with the smallest gap to the housing inner wall has the largest crest angle. This allows the construction of three-flight screw profiles with a ratio of outer diameter da to core diameter di of greater than 1.366. However, the screw elements designed according to this construction principle are disadvantageous because the screw crest with the narrowest gap and at the same time the largest crest angle has a zone of high shear stress for the polymer to be processed, in which damage may easily occur due to the high shear and temperature stress.

WO 02 09 919 A2 describes, among other things, three-flight and four-flight screw elements, wherein the crest angles at each screw crest of a three- or four-flight screw element can be designed differently. However, WO 02 09 919 A2 does not teach which embodiments are favorable with regard to their mixing and dispersing effect or their behavior during pressure build-up. The design specification for these elements is limited to transitional elements (referred to there as ‘fractional elements’) between one- and three-flight elements or between two- and four-flight elements, which restricts the freedom.

EP 1 093 905 A2 describes screw profiles for three-flight, self-cleaning screw element pairs for twin-screw extruders with a high distributive and dispersive mixing effect. However, the screw elements described there have the disadvantage that they have a wide crest angle at the point with the narrowest gap to the housing inner wall, which results in a zone with high energy dissipation and a high local temperature peak, which can lead to damage in the case of sensitive polymers.

The invention was based on the task of providing a screw element with which an improved mixing and dispersing effect compared to the prior art can be achieved with simultaneously good heat transfer.

The pair of three-flight screw elements according to the invention should also provide the extrudate with more volume in the housing bore than conventional three-flight screw elements.

In addition, the two screw elements of the pair of screw elements according to the invention should practically scrape each other when used as intended.

Surprisingly, it has now been found that the problem is solved by a pair of screw elements having the features of the main claim.

In the context of the present invention, the following terms apply:

A screw profile is a closed convex curve. A screw profile is made up of several different curves, which—depending on their geometric properties—are referred to as a “crest”, a “flank” or a “groove.” A crest always adjoins a flank on both sides. A groove always adjoins a flank on both sides. Crests and grooves, separated from each other by a flank, always occur alternately in a screw profile in the same direction. This results in the sequence crest—flank—groove—flank—crest—etc.

A curve is an unbroken line with a length, but no width, wherein a curve has a first end point and a second end point that are not one and the same point; that is to say, the first end point does not coincide with the second end point.

A curve can be composed of several curve sections, wherein a first curve section has a common point of contact with a second curve section that is directly neighboring the first curve section.

However, a curve can also consist of exactly one curve section.

A curve section is a section of a curve, wherein the curve section has a first end point and a second end point that are not one and the same point; that is to say, the first end point does not coincide with the second end point.

The mathematical expressions on which a curve section is based are preferably selected from the group of mathematical expressions comprising the following members: circular arc, elliptical arc, parabolic arc, longitudinal equidistant calculation rule according to [1], pages 117 to 121, circular equidistant arithmetic rule and spatial equidistant arithmetic rule. To produce a constant clearance when the screw elements are cleaned against each other, the longitudinal equidistant calculation rule or the circular equidistant calculation rule is preferred.

It is also true for a curve section k that it is a line that can be represented in a parameter representation of its arc length l

$$\vec{k} ( l ) = ( \begin{matrix}{x}_{k , l} ( l ) \\ {y}_{k , l} ( l )\end{matrix} )$$

and where x_{k,l}(l) and y_{k,l}(l) are analytical functions and x and y are the coordinates of the line in the plane and can therefore be represented by infinite power series, are continuous, can be differentiated any number of times and are therefore kink-free.

The longitudinal equidistant calculation rule is disclosed in [1], pages 117 to 121.

The circular equidistant rule is based on the assumption of a precisely scraping screw profile in the x-y plane of a Cartesian coordinate system, wherein a perpendicular is dropped in the direction of the center of rotation DP at each point of the screw profile. The point that is displaced by half the clearance along this perpendicular to the center of rotation then belongs to the technically executed screw profile. If, for example, a portion of a precisely scraping screw profile is a circular arc with radius rᵢ, the corresponding section of the associated technically executed screw profile is a circular arc with the same center and radius

$${r}_{i} - \frac{s}{2} .$$

The spatial equidistant is mentioned in [1], page 41; a spatial equidistant is available, for example, through a parameter representation. The spatial equidistant is explained in detail in the international patent application number PCT/EP2023/058951.

A closed, convex curve is an uninterrupted line with a non-zero length, but no width, composed of one or more curves, which in turn are composed of one or more curve sections. It does not have a marked start and end point. Starting from any point on the curve, it is possible to determine the length of the curve by adding up the length of the curve sections once around the curve. Every tangent to a closed, convex curve lies outside the area enclosed by the curve.

As all curve sections of a screw profile are located in one plane, a closed curve, which is a screw profile, divides the area of this plane into an area inside the closed curve and an area outside the closed curve.

A circular arc is a curve section in which all points of the circular arc have the same distance, called the radius, from a common center point. An arc has a starting point and an end point that are not one and the same point.

A circular arc is only considered to be a circular arc if all points of this circular arc have the same center and the same radius and the points of this circular arc form an uninterrupted curve section; in other words, two directly adjacent circular arcs that have a common point of contact are only considered to be two circular arcs if they have a different center or a different radius.

A circular arc with the center coordinates xₘ, yₘ and the radius r has, as is generally known, the parameter representation

$$x = {x}_{m} + r \cdot cos β$$

$$y = {y}_{m} + r \cdot sin β$$

wherein for the parameter β:

$${β}_{a} \leq β \leq {β}_{e}$$

whereby the start angle of a circular arc βₐ and the end angle of a circular arc βe are defined and βₑ<βₐ+π applies in radians. For a point with the coordinates x, y, it is defined that the start angle is equal to the end angle with respect to a labeled point with the coordinates xₘ>yₘ, so that according to the above equations, the following applies

$${β}_{a} = β = {β}_{e}$$

A circular arc has the starting point AP with the coordinates with the coordinates xₐ and yₐ

$${x}_{a} = {x}_{m} + r \cdot cos {β}_{a}$$

$${y}_{a} = {y}_{m} + r \cdot sin {β}_{a}$$

The center angle of a circular arc (also called the angle of a circular arc for short) is

$$α = {β}_{e} - {β}_{a}$$

A circular arc is completely defined by specifying the center point coordinates, the coordinates of the starting point AP and the center angle. The radius r is then the distance of the center point from the starting point AP. In the tables below, the radius for characterizing the circular arcs is also given for the sake of clarity.

The radius of curvature is the amount of the reciprocal of the curvature of the circle of curvature at a given point on a curve segment, wherein the circle of curvature at that point is the circle that best approximates the curve at that point, as described, for example, on Wikipedia (https://de.wikipedia.org/wiki/Kr % C3% BCmmungskreis, retrieved on 4 May 2023).

The center of rotation DP of a screw profile is the point of intersection of the axis of rotation of a screw element with the cross-sectional plane at right angles to this axis of rotation X. The center of rotation of the screw profile, hereinafter also referred to as the center of rotation for short, also coincides with the center of the housing bore in which the respective screw element is located or for which the respective screw element is designed.

In relation to a screw profile, a center of rotation is the point around which a screw profile rotates as a cross-sectional image of a screw element.

The outer radius RA of a screw profile is the maximum distance of the screw profile from the center of rotation; the outer radius RA is therefore the radius of the circle that encloses the entire screw profile and the center of which is the center of rotation associated with this screw profile.

The inner radius R1 of a screw profile is the minimum distance of the screw profile from the center of rotation.

A crest is:
(i) either exactly a circular arc of a screw profile which has the center of rotation of the screw profile as center point and in which all points of this circular arc have a greater distance from the center of rotation than the two curve sections immediately neighboring the crest, except for the common points of contact with the two curve sections immediately neighboring the crest;
(ii) or a point of a screw profile which has a greater distance from the center of rotation than the two points immediately adjacent to this point; the point which is a crest according to this case (ii) is thus a local maximum of the screw profile with respect to the distance from the center of rotation. Preferably, in case (ii), the point which is a crest is a point of a circular arc of which the radius is smaller than the distance between this point and the center of rotation. Here, in case (ii), the point which is a crest can be the middle point of a circular arc of which the radius is smaller than the distance between this point and the center of rotation.

In case (ii), the curves immediately adjacent to the crest merge into one another tangentially at the point that is the crest.

In case (i), the crest angle is the angle of the circular arc, i.e., the difference between the end angle and the start angle. In case (ii) it is zero.

The crest radius is in case (i) the distance of the respective crest, which is a circular arc, from the center of rotation of a screw profile, and in case (ii) is the distance of the point, which is a crest, from the center of rotation of the screw profile.

A groove is:
(iii) either exactly a circular arc of a screw profile which has the center of rotation of the screw profile as center point and in which all points of this circular arc have a smaller distance from the center of rotation than the two curve sections immediately neighboring the groove, except for the points of contact with the two curve sections immediately neighboring the groove;
(iv) or a point of a screw profile which has a smaller distance from the center of rotation than the two points immediately adjacent to this point; the point which is a crest according to this case (iv) is thus a local minimum of the screw profile with respect to the distance from the center of rotation. Preferably, in case (iv), the point which is a groove is a point of a circular arc of which the radius is greater than the distance between this point and the center of rotation. Here, in case (ii), the point which is a groove can be the middle point of a circular arc of which the radius is greater than the distance between this point and the center of rotation. In case (iv), the curves immediately adjacent to the groove merge into one another tangentially at the point that is the groove.

In case (iii), a groove angle is the angle of the circular arc, i.e., the difference between the end and start angles. In case (iv) it is zero.

A groove radius is in case (ii) the distance of the respective groove, which is a circular arc, from the center of rotation of a screw profile, and in case (iv) is the distance of the point, which is a groove, from the center of rotation of the screw profile.

A flank is a curve of a screw profile in which all points of this curve, apart from the common point of contact with a first curve section immediately adjacent to the flank, have a smaller distance from the center of rotation than this first curve section immediately adjacent to the flank and at the same time all points of this curve, apart from the common point of contact with a second curve section immediately adjacent to the flank, have a greater distance from the center of rotation than this second curve section of the screw profile immediately adjacent to the flank.

A flank can be composed of several curve sections to which the above definition applies. A flank is then represented by a convex curve made up of several curve sections, wherein the radii of curvature of the curve sections are always smaller than the center distance A.

According to the invention, a flank is preferably formed from a convex curve of which the curve sections are formed exclusively from circular arcs with a radius smaller than or equal to center distance A and, according to the invention, a flank is particularly preferably formed by exactly one circular arc with a radius smaller than center distance A. According to the invention, it is particularly preferred that all flanks of a screw cross-sectional profile are each formed by exactly one circular arc with a radius smaller than center distance A.

Two screw profiles are said to be congruent in the same direction if they can be transformed into one another by a shift and a rotation. Two screw profiles are said to be congruent in opposite directions if they can be transformed into one another by a shift, a rotation and a mirror image. Two screw profiles are said to be congruent without rotation if they can be transformed into each other by a displacement.

The screw profile according to the invention has exactly six flanks. The following is preferred according to the invention:
for each of the six flanks the following applies independently of each of the other five flanks:
one flank is formed from exactly one single circular arc, wherein this circular arc has a center point that is not the center of rotation of the screw profile,
or
one flank can be formed exclusively from a plurality of circular arcs, wherein, for the center points of all of these circular arcs, it is true that these center points are different from the center of rotation of the screw profile,
or
a flank can be formed from at least one circular arc and at least one curve section that is not a circular arc, wherein no circular arc has a center point that is the center of rotation of the screw profile,
or
a flank can be formed from only a single curve section that is not a circular arc,
or
a flank can be formed exclusively from a plurality of curve sections, none of which is a circular arc.

Alternatively, according to the invention, a flank is preferably formed from a convex curve of which the curve sections are formed exclusively according to a longitudinal section equidistant, circular equidistant or spatial equidistant calculation rule, and according to the invention, a flank is particularly preferably formed by exactly one curve section formed exclusively according to a longitudinal section equidistant, circular equidistant or spatial equidistant calculation rule. Alternatively, according to the invention it is particularly preferred that all flanks of a screw cross-sectional profile are formed exclusively according to a longitudinal section equidistant, circular equidistant or spatial equidistant calculation rule, and according to the invention it is particularly preferred that all flanks of a screw cross-sectional profile are each formed by exactly one curve section formed exclusively according to the longitudinal section equidistant, circular equidistant or spatial equidistant calculation rule. Alternatively, and in particular preferably, all curves of a screw profile are formed according to the same longitudinal section equidistant, circular equidistant or spatial equidistant calculation rule.

For the purposes of the present invention, a screw element is described as having three flights if it has exactly three crests.

In particular, the object is achieved by a pair of three-flight screw elements,
wherein the pair of screw elements consists of the screw element SE and the screw element SE′,
and
wherein the pair of screw elements SE and screw element SE′ is suitable for a multi-shaft screw machine
with m screw shafts SW1 to SWm rotating in the same direction and at the same speed, the respective neighboring axes of rotation X1 to Xm of which have a center distance A in a cross section at right angles to the axes of rotation and
with m circular housing bores which penetrate one another, each of which has an identical housing inner radius R and the bore centers M1 to Mm of which are at a distance which is the same as the center distance A, and the bore centers M1 to Mm of which coincide with the respective associated axes of rotation X1 to Xm of the screw shafts SW1 to SWm,
wherein the screw element SE has a screw profile SP and the screw element SE′ has a screw profile SP′, wherein it is true that
(1) each of the two screw profiles SP and SP′ is a closed convex curve, wherein this closed convex curve is composed merely of curve sections of which the radii of curvature are less than or equal to the center distance A,
(2) either neither of the two screw profiles SP and SP′ exhibits mirror symmetry, wherein in the context of the present invention a screw profile is mirror-symmetrical if it is mapped onto itself by the perpendicular axis mirroring on any axis running through the respective center of rotation, or the screw profiles SP and SP′ are not congruent to one another,
(3) each of the two screw profiles SP and SP′ has precisely three grooves,
(4) each of the two screw profiles SP and SP′ has exactly three crests-peripherally labeled K1, K2, K3 for the screw profile SP and K1′, K2′, K3′ for the screw profile SP′,
(6) two screw elements of the pair of screw elements located oppositely in pairs and directly adjacently to one another on two of the screw shafts of the multishaft screw machine, which rotate in the same direction and at the same speed, practically clean one another in pairs,
(7) a groove is separated from the nearest point of a neighboring crest by a flank,
(8) it has exactly six curves, which are flanks, wherein, in particular, it is true that
(9) r(Ki) is the crest radius of the crest Ki and r(Ki′) is the crest radius of the crest Ki′, wherein the following is true:
   r(K1)>r(K2) and r(K1)>r(K3) and r(K1′)>r(K2′) and r(K1′)>r(K3′) and r (K2)≥r(K3) and r(K2′)≥r(K3′) and at least one of the conditions a) or b), wherein
   a) r(K2)> (K3) and r(K2′)>r(K3′)
   b) r(K2) is unequal to r(K2′) and r(K3) is unequal to r(K3′)
   wherein r(K1) is the crest radius of the screw crest K1 and r(K2) is the crest radius of the screw crest K2 and r(K3) is the crest radius of the screw crest K3, and r(K1′) is the crest radius of the screw crest K1′, and r(K2′) is the crest radius of the screw crest K2′ and r (K3′) is the crest radius of the screw crest K3′,
(10) the screw crest K1 has the crest angle KW1, the screw crest K2 has the crest angle KW2, the screw crest K3 has the crest angle KW3 and the screw crest K1′ has the crest angle KW1′, the screw crest K2 has the crest angle KW2′ and the screw crest K3 has the crest angle KW3′, wherein
   (10.1) (10.1.a) when KW1>0, then KW1<KW2 and KW1<KW3, and
      (10.1.b) when KW1′>0, then KW1′<KW2 and KW1<KW3, or
   (10.2) (10.2.a) when KW1>0, then KW1<KW2 and KW1<KW3, and
      (10.2.c) when KW1′=0; then KW2>=0 and KW3>=0, or
   (10.3) (10.3.b) when KW1′>0, then KW1′<KW2 and KW1<KW3, and
      (10.3.d) when KW1=0, then KW2>=0 and KW3>=0, or
   (10.4) (10.4.d) when KW1=0, then KW2>=0 and KW3>=0, and
      (10.4.c) when KW1′=0; then KW2>=0 and KW3>=0,
   wherein r(K1) equals r(K1′) equals the outer radius RA or RA′ of the screw elements
   and m is an integer greater than 1, preferably from 2 to 16, particularly preferably 2, 3, 4, 6, 8, 10, 12 and 16,
   and i may assume the values 1, 2 or 3,
   and the outer radius RA is the radius of the circle which encloses the entire screw profile and of which the center point is the center of rotation associated with this screw profile, wherein the crest K1 is a segment of this circle.

The following results for the screw profiles according to the invention:

The three respective screw crests K1, K2, K3 and K1′, K2′ and K3′ (summarized as Ki and Ki′ respectively) of the screw elements according to the invention have gaps S1, S2, S3 and also S1′, S2′ and S3′ to the housing inner wall, wherein S1 or S1′ is the gap between screw crest K1 or K1′ and the housing inner wall, S2 or S2′ is the gap between screw crest K2 or K2′ and the housing inner wall, S3 or S3′ is the gap between screw crest K3 or K3′ and the housing inner wall, wherein the following relationships apply:

For the purposes of the present invention, a gap S is defined as the distance between a screw crest and the housing inner wall, thus obeying the equation S1=R−r(Ki), and Sᵢ=R−r(Ki), that is to say S1=R−r(K1), S2=R−r(K2) and S3=R−r(K3) and also Si′=R-r(Ki′), that is to say S1′=R−r(K1′), S2′=R−r(K2′) and S3′=R−r(K3′).

For features under number (10), the following is preferred in accordance with the invention:
(10.1) (10.1.a) when KW1>0, then KW1<KW2 and KW1<KW3,
   and
   (10.1.b) when KW1′>0, then KW1′<KW2 and KW1<KW3, or
(10.4) (10.4.c) when KW1=0, then KW2>=0 and KW3>=0, and
   (10.4.d) when KW1′=0; then KW2>=0 and KW3>=0.

Furthermore, the following applies to the screw elements according to the invention:

Each crest Ki or Ki′ corresponds to a groove Ni′ or Ni on the corresponding screw element, i.e., N1′ to K1, N2′ to K2, N3′ to K3, N1 to K1′, N2 to K2′, N3 to K3′. For each of the two screw elements SE and SE′ according to the invention, the following equation applies to the groove radius r(Ni′): r(Ni′)=R1+Si−S1 and correspondingly r(Ni)=R1′+Si′−S1′, and that for the start angle of the crest i and the start angle of the groove i′ B_{a,ki}≥β_{a,Ni′}+π and for the end angle of the crest i and the end angle of the groove i′ β_{e,Ki}≤β_{e,Ni′}+π and for the start angle of the crest i′ and the start angle of the groove i it is true that β_{a,Ki′}−π≥β_{a,Ni} and β_{e,ki′}−π≤β_{e,Ni}. It is always true that KWi≤NWi′ and KWi′≤NWi. In other words: a crest Ki of one screw element of a pair of screw elements according to the invention and a groove Ni′ of the other screw element of this pair of screw elements according to the invention lie on opposite sides—in relation to their respective screw element.

The pair of screw elements according to the invention achieves an improved mixing and dispersing effect compared to the prior art, with good shearing and good heat transfer at the same time, and it is ensured that two screw elements according to the invention, which are located directly adjacent to each other on two directly adjacent screw shafts, practically clean each other.

Due to the larger gaps of the crests K2 and K3 compared to the gap of the crest K1, the energy input is reduced in the screw element according to the invention compared to conventional screw elements known in the prior art. Surprisingly, the pair of three-flight screw elements according to the invention nevertheless exhibits an excellent mixing effect.

In a preferred embodiment according to the invention of the three-flight pair of screw elements according to the invention, the following also applies to screw profiles with the features shown under (1) to (10):
(11) each of the three crests K1, K2 and K3 of the screw element SE is formed in each case from only one curve section, which is a circular arc, the center of which is the center of rotation DP common to the crests K1, K2 and K3, and each of the three crests K1′, K2′ and K3′ of the screw element SE′ is likewise formed in each case from only one curve section, the center of which is the center of rotation DP′ common to the crests K1′, K2′ and K3′,
and
   each of the three grooves of the screw element SE is formed from only one respective curve section, which is a circular arc, the center of which is the center of rotation DP of the screw element SE common to the three grooves, and wherein there is exactly one groove, the distance of which from the center of rotation DP is smaller than the distances of the other grooves from the center of rotation DP, and that each of the three grooves of the screw element SE′ is formed from only one respective curve section, which is a circular arc, the center of which is the center of rotation DP′ of the screw element SE′ common to the three grooves.

For this preferred case according to the invention with the additional feature (11), it also applies that the core radius R1 is the radius of the groove with the smallest radius-starting from the center of rotation DP of the screw profile—of all grooves of the screw element SE and likewise the core radius R1′ is the radius of the groove with the smallest radius-starting from the center of rotation DP of the screw profile—of all grooves of the screw element SW′, wherein R1 is preferably equal to R1′.

For this preferred case according to the invention with the additional feature (11), it also applies that the outer radius RA is the radius of the crest with the largest radius-starting from the center of rotation DP of the screw profile—of all crests of the screw element SE and likewise the outer radius RA′ is the radius of the crest with the smallest radius-starting from the center of rotation DP′ of the screw profile—of all crests of the screw element SW′, wherein R^{A} is preferably equal to RA′.

In this preferred embodiment according to the invention, the circular arcs which represent the exactly three grooves have the same center point, namely the center of rotation of the one element, as do the circular arcs which represent the exactly three crests K1, K2 and K3. The center of rotation DP is therefore the common center point of all three crests K1, K2 and K3 as well as of all three grooves.

As a result, in this preferred embodiment according to the invention, a screw profile has a kink at all transitions from a screw crest to a flank. A kink in the screw profile means that an edge is formed in the screw element at the corresponding point. Mathematically, a kink means that a curve is not continuously differentiable at the point of the kink.

In a preferred embodiment according to the invention of the pair of three-flight screw elements according to the invention, the following also applies for screw profiles with the features shown under (1) to (10) or for screw profiles with the features shown under (1) to (10) and with the additional feature (11):
(12) both in the case of screw profile SP, the screw crest with the largest crest radius r(Ki), i.e., crest K1, has the smallest crest angle of crests K1, K2 and K3, and in the case of screw profile SP′, the screw crest with the largest crest radius r(Ki)′, i.e., crest K1′, has the smallest crest angle of crests K1′, K2′ and K3′.

In this way, the energy input is reduced and the thermal load on the polymer is reduced. For the multishaft screw machine described above, this means that the screw crest with the narrowest gap to the housing inner wall, i.e., the crest K1 with the gap S1, has the smallest crest angle. The same is true for the crest K1′ and the gap S1′.

According to the invention, it is also the case that two screw elements according to the invention, which are located directly adjacent to each other in pairs on two screw shafts of the described multishaft screw machine, practically clean each other in pairs; such two screw elements according to the invention are referred to as a pair of screw elements according to the invention. The screw profiles of these two screw elements according to the invention can be the same or different.

According to the invention, it is preferred that all screw elements practically clean each other in pairs in a cross section at right angles to the screw shafts. Of course, this in turn applies except for the technically necessary clearances. Here, the screw profiles of these screw elements according to the invention may be the same or different.

In a further preferred embodiment according to the invention of the pair of three-flight screw elements according to the invention, the following also applies for screw profiles with the features shown under (1) to (10) or for screw profiles with the features shown under (1) to (11) or for screw profiles with the features shown under (1) to (12):
(13) that both the screw profile SP is continuously differentiable at all of the crests K1, K2 and K3 and the screw profile SP′ is continuously differentiable at all of the crests K1′, K2′ and K3′.

In a further preferred embodiment according to the invention of the three-flight pair of screw elements according to the invention, the following also applies for screw profiles with the features shown under (1) to (10) or for screw profiles with the features shown under (1) to (11) or for screw profiles with the features shown under (1) to (11) and with the additional feature (13):
(14) each of the three crests K1, K2 and K3 of the screw element SE are each formed from exactly one point, i.e., KW1=KW2=KW3=0, and likewise each of the three crests K1′, K2′ and K3′ of the screw element SE′ are each formed from exactly one point, i.e., KW1′=KW2′=KW3′=0.

In a further preferred embodiment according to the invention of the three-flight pair of screw elements according to the invention, the following also applies for screw profiles with the features shown under (1) to (10) or for screw profiles with the features shown under (1) to (11) or for screw profiles with the features shown under (1) to (12) or for screw profiles with the features shown under (1) to (13):
(15) the crests K1 and K1′ are formed from exactly one point and the crests K2 and K3 are each formed from exactly one circular arc of which the respective center coincides with the center of rotation DP, and the crests K2′ and K3′ are each formed from exactly one circular arc of which the respective center coincides with the center of rotation DP′, the crests K2 and K3 and the crests K2′ and K3′ thus each have a crest angle greater than zero.

In a further preferred embodiment according to the invention of the three-flight pair of screw elements according to the invention, the following also applies for screw profiles with the features shown under (1) to (10) or for screw profiles with the features shown under (1) to (11) or for screw profiles with the features shown under (1) to (12) or for screw profiles with the features shown under (1) to (13):
(16) all crests of screw profile SP and all crests of screw profile SP′ have a crest angle greater than zero.

The sequence of crests and grooves can be designed differently according to the invention. For characterization purposes, the sequence of crests and grooves is listed in a mathematically positive sense, starting from the crest K1 on the screw shaft SW.

In a further preferred embodiment according to the invention of the three-flight pair of screw elements according to the invention, the following also applies for screw profiles with the features shown under (1) to (10) or for screw profiles with the features shown under (1) to (10) with an additional feature of the features (11) to (16) or for screw profiles with the features shown under (1) to (10) with more than one additional feature of the features (11) to (16):
(17) for a given housing inner radius R in relation to a given center distance A and a given housing inner diameter D=2 R, the distance r(K1) of the crest K1 from the center of rotation is selected such that the following range applies for r(K1) or r(K1′):
   r(K1) is less than or equal to R—0.002 D and
   r(K1) is greater than or equal to R—0.05 D and
   r(K1′) is less than or equal to R—0.002 D and
   r(K1′) is greater than or equal to R—0.05 D.

In a further preferred embodiment according to the invention of the three-flight pair of screw elements according to the invention, the following also applies for screw profiles with the features shown under (1) to (10) or for screw profiles with the features shown under (1) to (10) with an additional feature of the features (11) to (17) or for screw profiles with the features shown under (1) to (10) with more than one additional feature of the features (11) to (17):
(18) for a given housing inner radius R in relation to a given center distance A and a given housing inner diameter D=2 R, the distance r(K1) of the crest K1 from the center of rotation is selected such that the following range preferably applies for the crests K2 and K2′:
   r(K2) is less than or equal to r(K1)—0.002 D and
   r(K2) is greater than or equal to r(K1)—0.08 D
   and r(K2′) is less than or equal to r(K1′)—0.002 D and
   r(K2′) is greater than or equal to r(K1′)—0.08 D
   wherein it is additionally true that r(K2) is greater than (r(K1)+r(N1))/2 and r(K2′) is greater than (r(K1′)+r(N1′))/2.

In a further preferred embodiment according to the invention of the three-flight pair of screw elements according to the invention, the following also applies for screw profiles with the features shown under (1) to (10) or for screw profiles with the features shown under (1) to (10) with an additional feature of the features (11) to (18) or for screw profiles with the features shown under (1) to (10) with more than one additional feature of the features (11) to (18):
(19) for a given housing inner radius R in relation to a given center distance A and a given housing inner diameter D=2 R, the distance r(K1) of the crest K1 from the center of rotation is selected such that the following range preferably applies for the crests K3 and K3′:
   r(K3) is greater than or equal to r(K1)—0.09 D
   and r(K3) is less than or equal to r(K2)
   and r(K3) is greater than or equal to r(K2)—0.05 D
   and r(K3′) is greater than or equal to r(K1′)—0.09 D
   and r(K3′) is less than or equal to r(K2′)
   and r(K3′) is greater than or equal to r(K2′)—0.05 D
   and also (r(K1)+r(N1))/2 and r(K3′) is greater than (r(K3′)+r(N1′))/2.

It follows, according to the invention,
for a multishaft screw machine
with m screw shafts SW1 to SWm rotating in the same direction and at the same speed, the respective neighbouring axes of rotation X1 to Xm of which each have an identical center distance A in a cross section at right angles to the axes of rotation, and
with m circular housing bores which penetrate one another, each of which has an identical housing inner radius R and the bore centers M1 to Mm of which are at a distance which is the same as the center distance A, and the bore centers M1 to Mm of which coincide with the respective associated axes of rotation X1 to Xm of the screw shafts SW1 to SWm,
the gap S1 in relation to the housing inner diameter D is preferably from S1/D=0.002 to S1/D=0.05, and the gap S1′ in relation to the housing inner diameter D is preferably from S1′/D=0.002 to S1′/D=0.05,
the gap S2 in relation to the housing inner diameter D is preferably from S2/D=0.004 to S2/D=0.082, and the gap S2′ in relation to the housing inner diameter D is preferably from S2′/D=0.004 to S2′/D=0.082,
the gap S3 in relation to the housing inner diameter D is preferably from S3/D=0.004 to S3/D=0.1, and the gap S3′ in relation to the housing inner diameter D is preferably from S3′/D=0.004 to S3′/D=0.1.

In a further preferred embodiment according to the invention of the three-flight pair of screw elements according to the invention, the following also applies for screw profiles with the features shown under (1) to (10) or for screw profiles with the features shown under (1) to (10) with an additional feature of the features (11) to (19) or for screw profiles with the features shown under (1) to (10) with more than one additional feature of the features (11) to (19):
(20) the crest angle KW1 is 0 degrees<KW1<10 degrees and preferably 2 degrees<KW1<8 degrees and the crest angle KW1′ is 0 degrees<KW1′<10 degrees and preferably 2 degrees<KW1′<8 degrees.

Alternatively, according to the invention, the crest angle KW1 is preferably 0 degrees if the screw profile at the crest is continuously differentiable, i.e., the screw profile at the crest has no kink.

In a further preferred embodiment according to the invention of the three-flight pair of screw elements according to the invention, the following also applies for screw profiles with the features shown under (1) to (10) or for screw profiles with the features shown under (1) to (10) with an additional feature of the features (11) to (20) or for screw profiles with the features shown under (1) to (10) with more than one additional feature of the features (11) to (20):
(21) the t screw profiles SP and SP′ of the two screw elements SE and SE′ of a pair of screw elements are congruent without rotation and can be converted into one another by a displacement from the center of rotation of one screw profile to the respective other screw profile. This means that the screw elements are identical. The sequence of crests and grooves of the screw profile SP is then K1 N2 K3 N1 K2 N3 or K1 N3 K2 N1 K3 N2.

In a further preferred embodiment according to the invention of the three-flight pair of screw elements according to the invention, the following also applies for screw profiles with the features shown under (1) to (10) or for screw profiles with the features shown under (1) to (10) with an additional feature of the features (11) to (20) or for screw profiles with the features shown under (1) to (10) with more than one additional feature of the features (11) to (20):
(22) the screw profiles SP and SP′ of the two screw elements SE and SE′ of a pair of screw elements are congruent in opposite directions and, by the sequence of operations
   displacement of the screw profile from the center of rotation of one screw profile to the center of rotation of the other screw profile,
   mirroring along the line connecting the centers of rotation,
   rotation of one of the screw profiles by an angle other than zero, can be transformed into one another.

Preferably, screw elements that are designed as conveying elements are designed according to the rule of the spatial equidistant and have crest angles that are all greater than zero.

Preferably, screw elements that are designed as kneading disks are designed according to the circular equidistant rule, and the profiles consist only of circular arcs. In a particularly preferred embodiment of such screw elements, the screw profiles are composed of circular arcs with two different radii, and all crest angles are 0.

A further subject of the present invention is the use of a pair of the screw elements according to the invention in a multishaft machine. Preferably, the pair of screw elements according to the invention is used in a twin-shaft screw machine, i.e., in a twin-screw extruder.

The present invention thus also relates to a multishaft screw machine equipped with a pair of the screw elements according to the invention. The multishaft screw machine is preferably equipped here with at least as many screw elements as the screw machine has shafts. The screw elements according to the invention are arranged here on the screw shafts in such a way that each of the screw elements according to the invention practically cleans itself with at least one other of the screw elements according to the invention.

The pair of screw elements according to the invention can be present in a multishaft screw machine in the form of kneading, conveying or mixing elements. It is possible to combine kneading, conveying and mixing elements in a screw machine. The pair of screw elements according to the invention can also be combined with other screw elements, for example those known in the prior art.

As is well known, it is a feature of a conveying element (see for example [1], pages 136-142) that the screw profile has continuous helical turns continuing in the axial direction. The conveying element may be right-handed or left-handed. The pitch of a conveying element according to the invention preferably lies in the range of 0.5 to 5 times the center distance A, and the axial length of a conveying element according to the invention is preferably in the range of 0.25 to 2 times the pitch. The length of the conveying element is particularly preferably equal to the pitch; the conveying element thus represents a complete rotation of the screw profile.

As is well known, it is a feature of a kneading element (see for example [1], pages 142-145) that a screw profile is continued in the axial direction in an offset manner axis-parallel in the form of kneading disks. The kneading disks can be arranged to be either right-handed or left-handed, resulting in either a conveying effect or a reverse conveying effect. An offset angle of 45° between two axially adjacent kneading disks results in a neutral arrangement without conveying effect for three-flight screws. The axial length of the kneading disks preferably lies in the range of 0.05 to 0.5 times the axial distance A. The axial distance between two adjacent kneading disks preferably lies in the range of 0.0005 to 0.02 times the axial distance A.

As is well known inter alia (see for example [1], pages 148-151), mixing elements are formed in that conveying elements are provided with openings in the screw flight lands. The mixing elements may be right-handed or left-handed. Their pitch preferably lies in the range of 0.1 to 10 times the axial distance A, and the axial length of the elements preferably lies in the range of 0.5 to 5 times the axial distance A. The openings are preferably U-shaped or V-shaped and are preferably arranged in the opposite direction or parallel to the axis.

The sequence of the screw elements consisting of conveying elements and/or kneading elements and/or mixing elements on a screw shaft is also referred to as screw configuration.

The screw element according to the invention may also be configured as a transition element, meaning that the screw profile at any point in the axial extent of the screw element is different than at another point in the axial extent of the screw element, wherein these different screw profiles cannot be transformed into one another by rotation.

The screw element according to the invention is suitable for the extrusion of plastic and viscoelastic masses, e.g., suspensions, pastes, glass, ceramic masses, metals in the form of a melt, plastics, plastic melts, polymer solutions, elastomer and rubber masses.

The present invention thus also relates to a multishaft screw machine equipped with at least one pair of the screw elements according to the invention.

The present invention therefore also relates to a method for extruding plastic or viscoelastic masses using a pair of screw elements according to the invention or using a screw machine equipped with a pair of screw elements according to the invention.

A plastic mass is understood to be a deformable mass. Examples of plastic masses are polymer melts, especially of thermoplastics, as well as elastomers, mixtures of polymer melts or dispersions of polymer melts with solids, liquids or gases.

Thermoplastic polymers, also known as thermoplastics, or mixtures of thermoplastic polymers from the following series are preferably used: polycarbonate, polyamide, polyester, in particular polybutylene terephthalate and polyethylene terephthalate, and polyether, thermoplastic polyurethane, polyacetal, fluoropolymer, in particular polyvinylidene fluoride, and polyether sulfones, polyolefin, in particular polyethylene and polypropylene, and polyimide, polyacrylate, in particular poly(methyl) methacrylate, and polyphenylene oxide, polyphenylene sulfide, polyetherketone, polyaryletherketone, styrene polymers, in particular polystyrene, and styrene copolymers, in particular styrene-acrylonitrile copolymer, and acrylonitrile-butadiene-styrene block copolymers and also polyvinyl chloride. Similarly preferably used are what are known as blends of the plastics listed, which a person skilled in the art understands to be a combination of two or more plastics.

Viscoelastic masses are materials and mixtures that exhibit time-, temperature- and frequency-dependent elasticity. Viscoelasticity is characterized by a partly elastic, partly viscous behavior. The material only relaxes incompletely after the external force is removed, the remaining energy is dissipated in the form of flow processes (retardation).

Examples of viscoelastic materials are styrene-butadiene rubber, natural rubber, butadiene rubber, isoprene rubber, ethylene-propylene-diene rubber, ethylene-propylene rubber, butadiene-acrylonitrile rubber, hydrogenated nitrile rubber, butyl rubber, halobutyl rubber, chloroprene rubber, ethylene-vinyl acetate rubber, polyurethane rubber, thermoplastic polyurethane, gutta-percha, arylate rubber, fluorinated rubber, silicone rubber, sulfide rubber and chlorosulfonyl polyethylene rubber. A combination of two or more of the rubbers listed, or a combination of one or more rubbers with one or more plastics, is of course also possible.

The plastic or viscoelastic masses to be extruded may be used in pure form or as mixtures with fillers and reinforcers, such as in particular glass fibers, as mixtures with one another or with other polymers, or as mixtures with customary polymer additives.

Additives may be added to the extruder in solid, liquid or solution form together with the polymer, or else at least some or all of the additives are fed to the extruder via a side stream.

Additives can impart a variety of properties to a polymer. Said additives may, for example, be plasticizers, colorants, pigments, processing aids, fillers, antioxidants, reinforcers, UV absorbers and light stabilizers, extender oils, metal deactivators, peroxide scavengers, basic stabilizers, nucleating agents, benzofurans and indolinones which have a stabilizing or antioxidant action, mold release agents, flame retardant additives, antistatic agents, dyes and melt stabilizers. Examples of fillers and reinforcers are carbon black, glass fibers, clay, mica, graphite fibers, titanium dioxide, carbon fibers, carbon nanotubes, ionic liquids and natural fibers.

As explained above, the pair of screw elements according to the invention are particularly suitable for the extrusion of viscoelastic masses. The method steps that can be carried out with the aid of this pair of screw elements are, for example, the mixing or dispersing of solids or liquids or gases. Solids can be, for example, the solid additives mentioned above. Liquids can be, for example, the abovementioned additives in liquid form, but also, for example, water. Gases can be nitrogen or carbon dioxide, for example.

In particular, a pair of screw elements according to the invention or a single-shaft or multishaft screw machine equipped with at least one pair of screw elements according to the invention can also be advantageously used for compounding thermoplastics, in particular polycarbonates or thermoplastic polyurethanes, with colorants, pigments or additives.

The present invention thus relates both to a method for compounding thermoplastics, in particular polycarbonates or thermoplastic polyurethanes, with colorants and additives using a pair of screw elements according to the invention and to the use of a pair of screw elements according to the invention for compounding thermoplastics, in particular polycarbonates or thermoplastic polyurethanes, with colorants and additives.

The invention is explained below by way of example with reference to the accompanying figures with the aid of preferred exemplary embodiments, wherein the features specified below may constitute an aspect of the invention either individually or in combination.

It should be noted that, for the purposes of the present invention, a center of rotation DP is the cross-sectional profile of an axis of rotation X. Screw elements of a twin-screw extruder located directly opposite each other with the axes of rotation X1 and X2 therefore have the centers of rotation DP1 and DP2, also referred to below as DP and DP′.

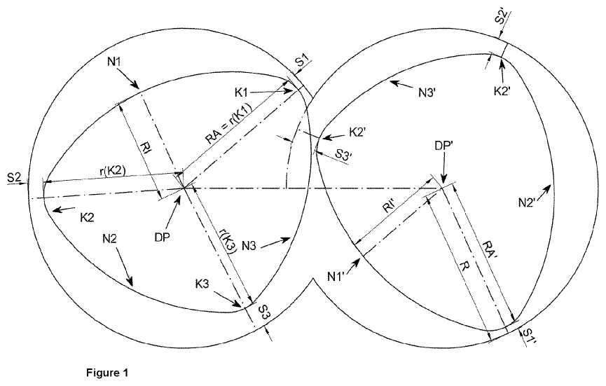

FIG. 1 shows a cross section of a pair of three-flight screw elements for a co-rotating twin-screw extruder, thus showing the screw cross-sectional profiles of these screw elements. The values R1 (inner radius of SP), RA (outer radius of SP), R1′ (inner radius of SP′), RA′ (outer radius of RA′), the gaps S1, S2 and S3 as well as S1′, S2′ and S3′ and the center of rotation DP and the center of rotation DP′ are shown to illustrate the geometric variables. Furthermore, the crests K1, K2 and K3 as well as K1′, K2′ and K3 and grooves N1, N2 and N3 as well as N1′, N2′ and N3 are shown as well as the crest radii r(K1), r(K2) and r(K3).

FIG. 1 shows the sequence of crests and grooves of the left-hand screw profile K1 N1 K2 N2 K3 N3.

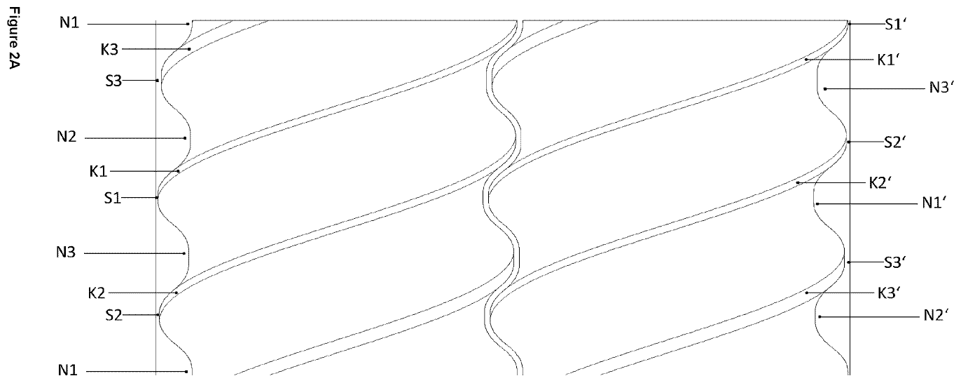

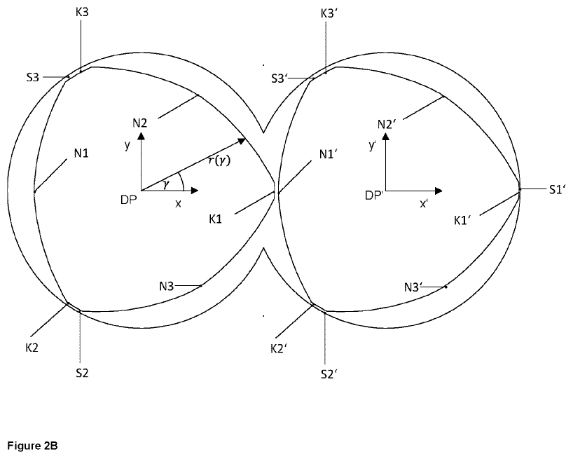

FIG. 2A shows a plan view of a pair of three-flight screw elements for a co-rotating twin-screw extruder according to the invention, which practically scrape each other. The housing wall is indicated by vertical lines in FIG. 2A. In this pair of screw elements according to the invention, the two screw profiles are identical.

The screw crests are labeled K1 to K3 on the left-hand screw element and K1′ to K3′ on the right-hand screw element; correspondingly the grooves are labeled as N1 to N3 and N1′ to N3′, respectively. The screw crest K1 cleans the housing inner wall with the gap S1, the screw crest K2 with the gap S2, and so on. The ratio A/D of center distance A to housing inner diameter D is 0.91.

The ratio S1/D is 0.005, the ratio S2/D is 0.01 and the ratio S3/D is 0.015. The screw elements SE and SE′ have an identical screw profile. The ratio of pitch to housing inner diameter T/D is 1. The crest angles are, given in radians, KW1=KW1′=0.1224, KW2=KW2′=0.1362 and KW3=KW3′=0.2306. The groove angles are, likewise in radians, NW1=NW1′=0.17453, NW2=5 NW2′=0.18789 and NW3=NW3′=0.28184.

The sequence of crests and grooves for the screw profile is K1 N2 K3 N1 K2 N3 or K1′ N2′ K3′ N1′ K2′ N3′.

FIG. 2B shows the screw profiles of the screw elements from FIG. 2A. The two screw profiles can be transformed into each other by shifting from the center of rotation DP of one screw element to the center of rotation DP′ of the other screw element. The coordinates of the screw profiles are given in table 2B.

TABLE 2B
Radial coordinates r(β)/D of the screw profiles that practically
clean one another in FIG. 2B read off in 2° steps for β, plus
the kinks, in relation to the housing inner diameters D.

| β | r(β)/D |
|---|---|
| 0.000 | 0.49500 |
| 2.000 | 0.49500 |
| 3.492 | 0.49500 |
| 4.000 | 0.49304 |
| 6.000 | 0.48556 |
| 8.000 | 0.47847 |
| 10.000 | 0.47177 |
| 12.000 | 0.46544 |
| 14.000 | 0.45947 |
| 16.000 | 0.45386 |
| 18.000 | 0.44860 |
| 20.000 | 0.44367 |
| 22.000 | 0.43907 |
| 24.000 | 0.43480 |
| 26.000 | 0.43083 |
| 28.000 | 0.42717 |
| 30.000 | 0.42381 |
| 32.000 | 0.42075 |
| 34.000 | 0.41797 |
| 36.000 | 0.41547 |
| 38.000 | 0.41325 |
| 40.000 | 0.41130 |
| 42.000 | 0.40961 |
| 44.000 | 0.40820 |
| 46.000 | 0.40704 |
| 48.000 | 0.40615 |
| 50.000 | 0.40551 |
| 52.000 | 0.40513 |
| 53.990 | 0.40500 |
| 54.000 | 0.40500 |
| 56.000 | 0.40500 |
| 58.000 | 0.40500 |
| 60.000 | 0.40500 |
| 62.000 | 0.40500 |
| 64.000 | 0.40500 |
| 64.755 | 0.40500 |
| 66.000 | 0.40505 |
| 68.000 | 0.40534 |
| 70.000 | 0.40588 |
| 72.000 | 0.40668 |
| 74.000 | 0.40774 |
| 76.000 | 0.40906 |
| 78.000 | 0.41064 |
| 80.000 | 0.41249 |
| 82.000 | 0.41461 |
| 84.000 | 0.41700 |
| 86.000 | 0.41968 |
| 88.000 | 0.42264 |
| 90.000 | 0.42589 |
| 92.000 | 0.42943 |
| 94.000 | 0.43328 |
| 96.000 | 0.43744 |
| 98.000 | 0.44192 |
| 100.000 | 0.44672 |
| 102.000 | 0.45186 |
| 104.000 | 0.45734 |
| 106.000 | 0.46317 |
| 108.000 | 0.46936 |
| 110.000 | 0.47593 |
| 112.000 | 0.48287 |
| 112.592 | 0.48500 |
| 114.000 | 0.48500 |
| 116.000 | 0.48500 |
| 118.000 | 0.48500 |
| 120.000 | 0.48500 |
| 122.000 | 0.48500 |
| 124.000 | 0.48500 |
| 125.803 | 0.48500 |
| 126.000 | 0.48426 |
| 128.000 | 0.47696 |
| 130.000 | 0.47006 |
| 132.000 | 0.46354 |
| 134.000 | 0.45739 |
| 136.000 | 0.45160 |
| 138.000 | 0.44616 |
| 140.000 | 0.44106 |
| 142.000 | 0.43630 |
| 144.000 | 0.43187 |
| 146.000 | 0.42775 |
| 148.000 | 0.42394 |
| 150.000 | 0.42044 |
| 152.000 | 0.41723 |
| 154.000 | 0.41431 |
| 156.000 | 0.41167 |
| 158.000 | 0.40931 |
| 160.000 | 0.40723 |
| 162.000 | 0.40542 |
| 164.000 | 0.40387 |
| 166.000 | 0.40259 |
| 168.000 | 0.40156 |
| 170.000 | 0.40080 |
| 172.000 | 0.40029 |
| 174.000 | 0.40003 |
| 176.000 | 0.40000 |
| 178.000 | 0.40000 |
| 180.000 | 0.40000 |
| 182.000 | 0.40000 |
| 184.000 | 0.40000 |
| 186.000 | 0.40003 |
| 188.000 | 0.40029 |
| 190.000 | 0.40080 |
| 192.000 | 0.40156 |
| 194.000 | 0.40259 |
| 196.000 | 0.40387 |
| 198.000 | 0.40542 |
| 200.000 | 0.40723 |
| 202.000 | 0.40931 |
| 204.000 | 0.41167 |
| 206.000 | 0.41431 |
| 208.000 | 0.41723 |
| 210.000 | 0.42044 |
| 212.000 | 0.42394 |
| 214.000 | 0.42775 |
| 216.000 | 0.43187 |
| 218.000 | 0.43630 |
| 220.000 | 0.44106 |
| 222.000 | 0.44616 |
| 224.000 | 0.45160 |
| 226.000 | 0.45739 |
| 228.000 | 0.46354 |
| 230.000 | 0.47006 |
| 232.000 | 0.47696 |
| 234.000 | 0.48426 |
| 235.502 | 0.49000 |
| 236.000 | 0.49000 |
| 238.000 | 0.49000 |
| 240.000 | 0.49000 |
| 242.000 | 0.49000 |
| 243.306 | 0.49000 |
| 244.000 | 0.48751 |
| 246.000 | 0.48060 |
| 248.000 | 0.47406 |
| 250.000 | 0.46789 |
| 252.000 | 0.46209 |
| 254.000 | 0.45663 |
| 256.000 | 0.45151 |
| 258.000 | 0.44672 |
| 260.000 | 0.44226 |
| 262.000 | 0.43811 |
| 264.000 | 0.43427 |
| 266.000 | 0.43074 |
| 268.000 | 0.42750 |
| 270.000 | 0.42455 |
| 272.000 | 0.42189 |
| 274.000 | 0.41951 |
| 276.000 | 0.41740 |
| 278.000 | 0.41556 |
| 280.000 | 0.41399 |
| 282.000 | 0.41268 |
| 284.000 | 0.41163 |
| 286.000 | 0.41085 |
| 288.000 | 0.41032 |
| 290.000 | 0.41004 |
| 291.140 | 0.41000 |
| 292.000 | 0.41000 |
| 294.000 | 0.41000 |
| 296.000 | 0.41000 |
| 298.000 | 0.41000 |
| 300.000 | 0.41000 |
| 302.000 | 0.41000 |
| 304.000 | 0.41000 |
| 306.000 | 0.41000 |
| 307.288 | 0.41000 |
| 308.000 | 0.41002 |
| 310.000 | 0.41024 |
| 312.000 | 0.41071 |
| 314.000 | 0.41144 |
| 316.000 | 0.41243 |
| 318.000 | 0.41369 |
| 320.000 | 0.41520 |
| 322.000 | 0.41698 |
| 324.000 | 0.41903 |
| 326.000 | 0.42136 |
| 328.000 | 0.42396 |
| 330.000 | 0.42685 |
| 332.000 | 0.43002 |
| 334.000 | 0.43349 |
| 336.000 | 0.43727 |
| 338.000 | 0.44134 |
| 340.000 | 0.44574 |
| 342.000 | 0.45046 |
| 344.000 | 0.45550 |
| 346.000 | 0.46089 |
| 348.000 | 0.46662 |
| 350.000 | 0.47271 |
| 352.000 | 0.47917 |
| 354.000 | 0.48600 |
| 356.000 | 0.49322 |
| 356.477 | 0.49500 |
| 358.000 | 0.49500 |

FIG. 2C shows a cross section of the precisely scraping pair of three-flight screw elements from FIGS. 2A and 2B, i.e., it shows the screw cross-sectional profiles of these screw elements. FIG. 2C shows the screw profiles of two screw elements that clean each other precisely, i.e. there is no clearance between the screw elements when the screw elements clean each other. In practice, a clearance other than zero will be set between the screw elements. As already mentioned further above, the procedure for this is presented, for example, in [1] on pages 40 and 41 and also 117 to 121. The circular arcs that make up the screw profiles are labeled with the numbers 1 to 12 for the left-hand screw profile and with the numbers 1′ to 12′ for the right-hand screw profile. The gaps between the screw crests and the housing inner wall are labeled S1 to S3 for the left-hand screw element and S1′ to S3′ for the right-hand screw element. Also shown as dashed lines are the construction lines for the circular arcs that make up the screw profiles.

The screw profiles of the screw elements in FIG. 2C consist only of circular arcs. The following table 1B lists the ratio of the radii rᵢ to the center distance A, the center angles, the coordinates of the circle centers (x_{m,i} and y_{m,i}) and the coordinates (xₐ and yₐ) of the starting points AP in relation to the center distance A of the respective circular arcs for the screw profiles from FIG. 2C with the circular arcs 1 to 12 and l′ to 12′. The circular arcs are numbered counterclockwise for the generating screw profile, in this case the left-hand screw profile, and clockwise for the generated screw profile, in this case the right-hand screw profile. All length dimensions are normalized to the distance A between the centers of rotation DP and DP′. The origin of the coordinates is located at the center of rotation of the respective screw profile. The specifications of the center angles αᵢ-are in radians. As the two screw profiles are identical, only one profile is specified in each case.

TABLE 2C
Details of the circular arcs of the screw profiles in figure 2C

| No. | $\frac{{r}_{i}}{A}$ | αᵢ | x_{α} A | y_{α}/A | x_{m,i}/A | y_{m,i}/A |
|---|---|---|---|---|---|---|
| 1, 1′ | 0.55220 | 0.17453 | 0.55010 | −0.04813 | 0.00000 | 0.00000 |
| 2, 2′ | 1.00000 | 0.42980 | 0.55009 | 0.04813 | −0.32142 | −0.44224 |
| 3, 3′ | 0.45330 | 0.18789 | 0.26651 | 0.36668 | 0.00000 | 0.00000 |
| 4, 4′ | 1.00000 | 0.40261 | 0.19333 | 0.41000 | −0.23316 | −0.49449 |
| 5, 5′ | 0.54121 | 0.28184 | −0.19518 | 0.50479 | 0.00000 | 0.00000 |
| 6, 6′ | 1.00000 | 0.41192 | −0.32787 | 0.43059 | 0.55010 | −0.04813 |
| 7, 7′ | 0.44780 | 0.17453 | −0.44610 | 0.03903 | 0.00000 | 0.00000 |
| 8, 8′ | 1.00000 | 0.42524 | −0.44610 | −0.03903 | 0.55010 | 0.04813 |
| 9, 9′ | 0.54670 | 0.18789 | −0.32142 | −0.44224 | 0.00000 | 0.00000 |
| 10, 10′ | 1.00000 | 0.40694 | −0.23316 | −0.49449 | −0.19518 | 0.50479 |
| 11, 11′ | 0.45879 | 0.28184 | 0.16546 | −0.42792 | 0.00000 | 0.00000 |
| 12, 12′ | 1.00000 | 0.42081 | 0.27794 | −0.36502 | −0.32787 | 0.43059 |

The profiles in FIGS. 2A and 2B are the screw profiles that practically clean each other that were derived from the profile in FIG. 2C during the manufacture of the screw elements. These screw profiles were calculated in such a way that the screw elements clean each other spatially with an equidistant clearance, i.e., were calculated using the spatial equidistant calculation rule. Alternatively, such screw profiles that practically clean each other can also be calculated using the longitudinal equidistant calculation rule.

FIG. 3 shows the screw profiles of another pair of screw elements according to the invention. The screw profiles are composed of circular arcs. Also shown as dashed lines are the construction lines for the circular arcs that make up the screw profiles. The screw profile of the left-hand screw element SE can, by the sequence of steps
displacement of the screw profile from the center of rotation of the left screw profile DP to the center of rotation of the right screw profile DP′,
mirroring at the line connecting the two centers of rotation,
rotation in a mathematically positive direction by 15°,
be transformed into the screw profile SE′. The screw profile of the left-hand screw element SE and the screw profile of the right-hand screw element SE′ are therefore congruent in opposite directions.

The ratio of the center distance to the housing inner diameter is A/D=0.82, the ratio of the gaps S1 and S1′ to the housing inner diameter S1/D=S1′/D=0.018, the ratio of the gap S2 and S2′ to the housing inner diameter S2/D=S2′/D=0.05 and the ratio of the gaps S3 and S3′ to the housing inner diameter S3/D=S3′/D=0.077136 and the ratio of the clearance between the screw profiles SW and SW's/D=0.022. All crest angles of this screw profile are KW1=KW2=KW3=KW1′=KW2′=KW3′=0.

The sequence of crests and grooves on the screw element is K1 N2 K2 N1 K3 N2.

Table 3A contains the list of circular arcs of the screw profile SW, relative to the coordinates x, y relative to the center of rotation DP.

TABLE 3A

| i | rᵢ/A | αᵢ | xₐ/A | yₐ/A | x_{m,i}/A | y_{m,i}/A |
|---|---|---|---|---|---|---|
| 1 | 0.068239 | 1.05238 | 0.473976 | −0.032106 | 0.413761 | 0 |
| 2 | 0.729761 | 1.13916 | 0.471485 | 0.036394 | −0.145823 | −0.352813 |
| 3 | 0.068239 | 1.13916 | −0.241076 | 0.370705 | −0.232169 | 0.30305 |
| 4 | 0.729761 | 1.05238 | −0.297345 | 0.323264 | 0.399663 | 0.107089 |
| 5 | 0.068239 | 0.95005 | −0.133478 | −0.391221 | −0.083624 | −0.344625 |
| 6 | 0.729761 | 0.95005 | −0.074717 | −0.41228 | −0.16997 | 0.311238 |

Table 3B shows the list of circular arcs of the screw profile SW′, relative to the coordinates x′, y′ relative to the center of rotation DP′.

TABLE 3B

| i | rᵢ/A | αᵢ | xₐ/A | yₐ/A | x_{m,i}/A | y_{m,i}/A |
|---|---|---|---|---|---|---|
| 1′ | 0.729761 | 1.05238 | −0.410185 | 0.343344 | 0.413761 | 0 |
| 2′ | 0.068239 | 1.13916 | −0.383547 | −0.389207 | −0.145823 | −0.352813 |
| 3′ | 0.729761 | 1.13916 | −0.316916 | −0.420468 | −0.232169 | 0.30305 |
| 4′ | 0.068239 | 1.05238 | 0.284839 | 0.086875 | 0.399663 | 0.107089 |
| 5′ | 0.729761 | 0.95005 | 0.269516 | 0.153685 | −0.083624 | −0.344625 |
| 6′ | 0.068239 | 0.95005 | −0.358877 | 0.378893 | −0.16997 | 0.311238 |

FIGS. 4A to 4H show various screw profiles according to the invention with different sequences of crests and grooves. For all these screw profiles, the ratio of the center distance to the housing inner diameter is A/D=0.82, the ratio of the gaps S1 and S1′ to the housing inner diameter S1/D=S1′/D=0.018 and the ratio of the clearance between the screw profiles SW and SW′ to the diameter s/D=0.022. All crest angles of the screw element according to the invention in FIGS. 4A to 4H are zero. The screw profile in FIG. 4E corresponds to that of example 2. Table 4 provides an overview of the various screw profiles; the crests and grooves Ki, Ni, Ki′ and Ni′ are also shown there. FIG. 4B shows screw profiles that are not congruent and have a mirror symmetry to the x-axis.

TABLE 4
Screw profiles of FIGS. 4A to 4H.

| | | | | | Crest-groove | | |
|---|---|---|---|---|---|---|---|
| FIGURE | S2/D | S3/D | S2′/D | S3′/D | sequence | Congruence | Symmetry |
| 4A | 0.05 | 0.05 | 0.077136 | 0.077136 | K1 N1 K2 N2 | none | none |
| | | | | | K3 N3 | | |
| 4B | 0.05 | 0.05 | 0.077136 | 0.077136 | K1 N2 K2 N1 | none | Mirror |
| | | | | | K3 N3 | | |
| 4C | 0.05 | 0.077136 | 0.05 | 0.077136 | K1 N1 K2 N2 | none | none |
| | | | | | K3 N3 | | |
| 4D | 0.05 | 0.077136 | 0.05 | 0.077136 | K1 N1 K2 N3 | in opposite | none |
| | | | | | K3 N2 | directions | |
| 4E | 0.05 | 0.077136 | 0.05 | 0.077136 | K1 N2 K2 N1 | in opposite | none |
| | | | | | K3 N3 | directions | |
| 4F | 0.05 | 0.077136 | 0.05 | 0.077136 | K1 N2 K2 N3 | none | none |
| | | | | | K3 N1 | | |
| 4G | 0.05 | 0.077136 | 0.05 | 0.077136 | K1 N3 K2 N1 | without | none |
| | | | | | K3 N2 | rotation | |
| 4H | 0.05 | 0.077136 | 0.05 | 0.077136 | K1 N3 K2 N2 | in opposite | none |
| | | | | | K3 N1 | directions | |

FIG. 5 shows the screw profiles of another pair of screw elements according to the invention. The screw profiles are composed of circular arcs. Also shown as dashed lines are the construction lines for the circular arcs that make up the screw profiles. The screw profile of the left-hand element SW can, by the sequence of steps
displacement of the screw profile from the center of rotation of the left screw profile DP to the center of rotation of the right screw profile DP′,
mirroring at the line connecting the two centers of rotation (here labeled Y)
rotation in a mathematically positive direction by 15.72025°, wherein the line Y is transformed into Y′,
be transformed into the screw profile SW′.

The ratio of the center distance to the crest angle is A/D=0.8, the ratio of gaps S1 and S1′ to the housing inner diameter is S1/D=S1/D=0.025, the ratio of gaps S2 and S2′ to D is S2/D=S2′/D=0.062 and the ratio of gaps S3 and S3′ to D is S3/D=S3′/D=0.095.

The crest angles are, given in radians, KW1=KW1′=0, KW2=KW2′=0.102871 and KW3=KW3′=0.162301. The groove angles are, likewise in radians, NW1=NW1′=0, NW2=NW2′=0.114586 and NW3=NW3′=0.171879.

The left and right screw profiles in FIG. 5 are composed of circular arcs, the radii of which based on the housing inner diameters rᵢ/D and rᵢ′/D, center angle, coordinates of the starting points relative to the origin of the coordinates x, y and x′, y′ based on the housing inner diameters SP_{x,i}/D and SP_{y,i}/D and, respectively, SP′_{x,i}/D and SP′_{y,i}/D, coordinates of the center of the circular arc relative to the diameters MP_{x,i}/D and MP_{y,i}/D are shown in tables 5A and 5B.

TABLE 5A

| i | αᵢ | $\frac{{r}_{i}}{D}$ | SP_{x,i}/D | SP_{y,i}/D | x_{m,i}/D | y_{m,i}/D |
|---|---|---|---|---|---|---|
| 1 | 0.060252 | 1.083640 | 0.467734 | −0.028684 | 0.414748 | 0.0000 |
| 2 | 0.790000 | 0.538798 | 0.464899 | 0.033394 | −0.192662 | −0.404457 |
| 3 | 0.342000 | 0.114586 | 0.147077 | 0.308759 | 0.0000 | 0.0000 |
| 4 | 0.790000 | 0.464125 | 0.110810 | 0.323551 | −0.145155 | −0.423833 |
| 5 | 0.438000 | 0.102871 | −0.250827 | 0.359068 | 0.0000 | 0.0000 |
| 6 | 0.719748 | 1.076264 | −0.286373 | 0.331413 | 0.399235 | 0.112372 |
| 7 | 0.405000 | 0.162301 | −0.118966 | −0.387133 | 0.0000 | 0.0000 |
| 8 | 0.790000 | 0.267960 | −0.054845 | −0.401269 | −0.164230 | 0.381121 |
| 9 | 0.375000 | 0.171879 | 0.148401 | −0.344387 | 0.0000 | 0.0000 |
| 10 | 0.790000 | 0.495861 | 0.205116 | −0.313931 | −0.226995 | 0.347417 |

TABLE 5B

| i | α_{i′} | $\frac{{r}_{i}^{′}}{D}$ | SP_{x′}/D | SP_{y′,i}/D | x_{m,i}/D | y_{m,i}/D |
|---|---|---|---|---|---|---|
| 1′ | 0.719748 | 1.076264 | −0.219406 | 0.340420 | 0.414748 | 0.0000 |
| 2′ | 0.438000 | 0.102871 | −0.185869 | −0.396607 | 0.0000 | 0.0000 |
| 3′ | 0.790000 | 0.464125 | −0.144159 | −0.413597 | −0.254559 | 0.368651 |
| 4′ | 0.342000 | 0.114586 | 0.194328 | −0.281426 | 0.0000 | 0.0000 |
| 5′ | 0.790000 | 0.538798 | 0.225231 | −0.257362 | −0.295039 | 0.337129 |
| 6′ | 0.060252 | 1.083640 | 0.456558 | 0.093815 | 0.399235 | 0.112372 |
| 7′ | 0.790000 | 0.495861 | 0.442467 | 0.154340 | −0.124375 | −0.395924 |
| 8′ | 0.375000 | 0.171879 | 0.112387 | 0.357763 | 0.0000 | 0.0000 |
| 9′ | 0.790000 | 0.267960 | 0.049541 | 0.371713 | −0.054826 | −0.411363 |
| 10' | 0.405000 | 0.162301 | −0.161514 | 0.371400 | 0.0000 | 0.0000 |

1. A pair of three-flight screw elements,
wherein the pair of screw elements consists of the screw element SE and the screw element SE′,
and
wherein the pair of screw elements SE and screw element SE′ is suitable for a multi-shaft screw machine
with m screw shafts SW1 to SWm rotating in the same direction and at the same speed, the respective neighboring axes of rotation X1 to Xm of which have a center distance A in a cross section at right angles to the axes of rotation and
with m circular housing bores which penetrate one another, each of which has an identical housing inner radius R and the bore centers M1 to Mm of which are at a distance which is the same as the center distance A, and the bore centers M1 to Mm of which coincide with the respective associated axes of rotation X1 to Xm of the screw shafts SW1 to SWm,
wherein the screw element SE has a screw profile SP and the screw element SE′ has a screw profile SP′, wherein it is true that
(1) each of the two screw profiles SP and SP′ is a closed convex curve,
wherein this closed convex curve is composed merely of curve sections of which the radii of curvature are less than or equal to the center distance A,
(2) either none of the two screw profiles SP and SP′ has mirror symmetry, or the screw profiles SP and SP′ are not congruent with each other,
(3) each of the two screw profiles SP and SP′ has precisely three grooves,
(4) each of the two screw profiles SP and SP′ has exactly three crests-peripherally labeled K1, K2, K3 for the screw profile SP and K1′, K2′, K3′ for the screw profile SP′,
(6) two screw elements of the pair of screw elements located oppositely in pairs and directly adjacently to one another on two of the screw shafts of the multishaft screw machine, which rotate in the same direction and at the same speed, practically clean one another in pairs,
(7) a groove is separated from the nearest point of a neighboring crest by a flank,
(8) it has exactly six curves, which are flanks,
wherein
(9) r(Ki) is the crest radius of the crest Ki and r(Ki′) is the crest radius of the crest Ki′, wherein the following is true:
r(K1)>r(K2) and r(K1)>r(K3) and r(K1′)>r(K2′) and r(K1′)>r(K3′) and r (K2)>r(K3) and r(K2′)>r(K3′) and at least one of the conditions a) or b), wherein
a) r(K2)>(K3) and r(K2′)>r(K3′)
b) r(K2) is unequal to r(K2′) and r(K3) is unequal to r(K3′)
wherein r(K1) is the crest radius of the screw crest K1 and r(K2) is the crest radius of the screw crest K2 and r(K3) is the crest radius of the screw crest K3, and r(K1′) is the crest radius of the screw crest K1′, and r(K2′) is the crest radius of the screw crest K2′ and r(K3′) is the crest radius of the screw crest K3′,
(10) the screw crest K1 has the crest angle KW1, the screw crest K2 has the crest angle KW2, the screw crest K3 has the crest angle KW3 and the screw crest K1′ has the crest angle KW1′, the screw crest K2 has the crest angle KW2′ and the screw crest K3 has the crest angle KW3′, wherein
(10.1) (10.1.a) when KW1>0, then KW1<KW2 and KW1<KW3,
and
(10.1.b) when KW1′>0, then KW1′<KW2 and KW1<KW3,
or
(10.2) (10.2.a) when KW1>0, then KW1<KW2 and KW1<KW3,
and
(10.2.c) when KW1′=0; then KW2>=0 and KW3>=0,
or
(10.3) (10.3.b) when KW1′>0, then KW1′<KW2 and KW1<KW3,
and
(10.3.d) when KW1=0, then KW2>=0 and KW3>=0,
or
(10.4) (10.4.d) when KW1=0, then KW2>=0 and KW3>=0,
and
(10.4.c) when KW1′=0; then KW2>=0 and KW3>=0,
wherein r(K1) equals r(K1′) equals the outer radius RA or RA′ of the screw elements
and m is an integer greater than 1,
and i may assume the values 1, 2 or 3,
and the outer radius RA is the radius of the circle which encloses the entire screw profile and of which the center point is the center of rotation associated with this screw profile, wherein the crest K1 is a segment of this circle.

2. The screw elements as claimed in claim 1, wherein
each of the three crests K1, K2 and K3 of the screw element SE is formed in each case from only one curve section, which is a circular arc, the center of which is the center of rotation DP common to the crests K1, K2 and K3, and each of the three crests K1′, K2′ and K3′ of the screw element SE′ is likewise formed in each case from only one curve section, the center of which is the center of rotation DP′ common to the crests K1′, K2′ and K3′,
and
each of the three grooves of the screw element SE is formed from only one respective curve section, which is a circular arc, the center of which is the center of rotation DP of the screw element SE common to the three grooves, and wherein there is exactly one groove, the distance of which from the center of rotation DP is smaller than the distances of the other grooves from the center of rotation DP, and that each of the three grooves of the screw element SE′ is formed from only one respective curve section, which is a circular arc, the center of which is the center of rotation DP′ of the screw element SE′ common to the three grooves.

3. The pair of screw elements as claimed in claim 1, wherein
both in the case of screw profile SP, the screw crest with the largest crest radius r(Ki has the smallest crest angle of crests K1, K2 and K3, and in the case of screw profile SP′, the screw crest with the largest crest radius r(Ki)′, i.e., crest K1′, has the smallest crest angle of crests K1′, K2′ and K3′.

4. The pair of screw elements as claimed in claim 1, wherein
both the screw profile SP is continuously differentiable at all of the crests K1, K2 and K3 and the screw profile SP′ is continuously differentiable at all of the crests K1′, K2′ and K3′.

5. The pair of screw elements as claimed in claim 1, wherein
each of the three crests K1, K2 and K3 of the screw element SE are each formed from exactly one point and likewise each of the three crests K1′, K2′ and K3′ of the screw element SE′ are each formed from exactly one point.

6. The pair of screw elements as claimed in claim 1, wherein
the crests K1 and K1′ are formed from exactly one point and the crests K2 and K3 are each formed from exactly one circular arc, the respective center of which coincides with the center of rotation DP, and the crests K2′ and K3′ are each formed from exactly one circular arc, the respective center of which coincides with the center of rotation DP′.

7. The pair of screw elements as claimed in claim 1, wherein
all crests of the screw profile SP and all crests of the screw profile SP′ have a crest angle greater than zero.

8. The pair of screw elements as claimed in claim 1, wherein
for a given housing inner radius R in relation to a given center distance A and a given housing inner diameter D=2 R, the distance r(K1) of the crest K1 from the center of rotation is selected such that the following range applies for r(K1) or r(K1′):
r(K1) is less than or equal to R—0.002 D and
r(K1) is greater than or equal to R—0.05 D and
r(K1\hat{ }′) is less than or equal to R—0.002 D and
r(K1′) is greater than or equal to R—0.05 D.

9. The pair of screw elements as claimed in claim 1, wherein
for a given housing inner radius R in relation to a given center distance A and a given housing inner diameter D=2 R, the distance r(K1) of the crest K1 from the center of rotation is selected such that the following range applies for the crests K2 and K2′:
r(K2) is less than or equal to r(K1)—0.002 D and
r(K2) is greater than or equal to r(K1)—0.08 D
and r(K2′) is less than or equal to r(K1′)—0.002 D and
r(K2′) is greater than or equal to r(K1′)—0.08 D,
wherein it is additionally true that r(K2) is greater than (r(K1)+r(N1))/2 and r(K2′) is greater than (r(K1′)+r(N1′))/2.

10. The pair of screw elements as claimed in claim 1, wherein
for a given housing inner radius R in relation to a given center distance A and a given housing inner diameter D=2 R, the distance r(K1) of the crest K1 from the center of rotation is selected such that the following range applies for the crests K3 and K3′:
r(K3) is greater than or equal to r(K1)—0.09 D
and r(K3) is less than or equal to r(K2)
and r(K3) is greater than or equal to r(K2)—0.05 D
and r(K3′) is greater than or equal to r(K1′)—0.09 D
and r(K3′) is less than or equal to r(K2′)
and r(K3′) is greater than or equal to r(K2′)—0.05 D
and also (r(K1)+r(N1))/2 and r(K3′) is greater than (r(K3′)+r(N1′))/2.

11. The pair of screw elements as claimed in claim 1, wherein
for the screw profiles SP and SP′, it is true, independently of each other, that
the crest angle KW1 is 0 degrees<KW1<10 degrees and the crest angle KW1′ is 0 degrees<KW1′<10 degrees.

12. The pair of screw elements as claimed in claim 1, wherein
screw profiles of the two screw elements SE and SE′ are either congruent without rotation or the screw profiles SP and SP′ of the two screw elements SE and SE′ are congruent in opposite directions.

13. A method comprising utilizing the pair of screw elements as claimed in claim 1 in a multishaft screw machine.

14. A multishaft screw machine, equipped with a pair of screw elements as claimed in claim 1.

15. A method for extruding plastic or viscoelastic masses using the pair of screw elements as claimed in claim 1.

16. The pair of screw elements as claimed in claim 1, wherein m is an integer in a range of 2 to 16.

17. The pair of screw elements as claimed in claim 1, wherein
for the screw profiles SP and SP′, it is true, independently of each other, that
the crest angle KW1 is 2 degrees<KW1<8 degrees and the crest angle KW1′ is 2 degrees<KW1′<8 degrees.
